(19) United States
(12) Patent Application Publication
(10) Pub. No.: US 2008/0191863 A1
(43) Pub. Date: Aug. 14, 2008

(54) GLOBAL EMERGENCY ALERT NOTIFICATION SYSTEM

(76) Inventors: Brian M. Boling, Knoxville, TN (US); Ronald D. Bishop, Trabucco Canyon, CA (US); Christopher P. Hoffman, Fareham (GB); Darryl T. Brown, Lenoir City, TN (US)

Correspondence Address: LUEDEKA, NEELY & GRAHAM, P.C., P O BOX 1871, KNOXVILLE, TN, 37901, US

(21) Appl. No.: 11/954,725

(22) Filed: Dec. 12, 2007

Related U.S. Application Data
(63) Continuation-in-part of application No. 11/669,239, filed on Jan. 31, 2007.
(60) Provisional application No. 60/764,419, filed on Feb. 2, 2006.
(60) Provisional application No. 60/887,726, filed on Feb. 1, 2007.

(51) Int. Cl. G08B 19/00; H04M 11/04

(52) U.S. Cl. 340/521; 455/404.1; 379/42

(57) ABSTRACT

An emergency event reporting apparatus operates in conjunction with a satellite-based data relay system. The emergency event reporting apparatus includes an emergency alert transmission system and an emergency alert management system. The emergency alert transmission system transmits emergency alert messages upon detection of an emergency event. The emergency alert transmission system includes one or more emergency alert sensors, an alarm control panel and an alarm beacon unit. The emergency alert sensors detect characteristics associated with the emergency event and generate sensor signals based thereon. The alarm control panel receives the sensor signals and generates alarm signals based thereon. The alarm beacon unit receives the alarm signals and transmits an alert message based on the alarm signals. The alert message includes identification information and alert message information regarding the alarm signals. The alarm beacon unit transmits the alert message at a frequency and in a format compatible with reception and processing by satellites associated with the satellite-based data relay system. The emergency alert management system is operable to receive communications from the satellite-based data relay system, and to extract the identification information and the alert message information from the communications.

This continuation-in-part application claims priority to the following co-pending patent applications, the entire contents of which are incorporated herein by reference:
Ser. No. 11/669,239 filed Jan. 31, 2007 titled GLOBAL EMERGENCY ALERT NOTIFICATION SYSTEM which claims priority to provisional patent application No. 60/764,419 filed Feb. 2, 2006 titled GLOBAL EMERGENCY SYSTEM; and
Ser. No. 60/887,726 filed Feb. 1, 2007 titled GLOBAL EMERGENCY ALERT NOTIFICATION SYSTEM

### FIELD

This invention relates to a global emergency event reporting system. More particularly, this invention relates to detecting an emergency event and reliably reporting that event, regardless of location, to appropriate authorities who can then direct rescue services to the location of the emergency event or activate alarm devices to provide warning of the emergency event.

### BACKGROUND

In today's mobile society, safety and security of individuals whether in the home, in the workplace, or when traveling through a remote location is a primary concern. The universal nature of this concern is exhibited by the fact that 95% of all households list security as their primary reason for purchasing a cellular telephone. However, the lack of global cellular network coverage and frequent service reliability problems inherent in cellular communications make a cell phone a less than ideal personal safety device for individuals that are at high risk of injury and are frequently out of range of reliable cellular phone service, such as hikers, hunters, boaters, remote workers and travelers to high risk regions. Additionally, cellular phones provide a less than ideal means of notifying rescue authorities of an emergency in situations wherein a user is at a high risk of incapacitation, such as automobile crashes, home break-ins or fires, and in situations where a high degree of third party monitoring is necessary, such as in the monitoring of hazardous material carriers.

There are currently a few devices and systems in the consumer market that attempt to address these concerns. However, those devices and systems have significant deficiencies.

Alarm Reporting Systems

For the last several years, the alarm reporting industry has provided security services to both private residences and small businesses using electronic control panels and central station monitoring equipment that communicates using Dual Tone Multiple Frequency (DTMF) modulation which is supported by local Public Switched Telephone Networks (PSTN). In receiving reports of real-time alarm events, DTMF receiving units at the central monitoring stations perform handshakes and decipher identification strings of data sent by the alarm control panels in order to determine the identification of the customer and the specific nature of the alarm. The two-way capacity of the PSTN also facilitates the ability of the central station operators to send confirmation return requests back to the alarm control units.

In many cases, the providers of electronic security services provide a secondary fully redundant wireless backup communications method that transports the alarm reporting DTMF strings to the central station in the event the local telephone hard-wired services or primary electrical power sources were either deliberately or accidentally disrupted. The wireless system(s) of choice used to communicate the backup alarms have been local cellular communication services. This type of redundant security service brings with it the added costs for both the equipment and monthly cellular service fees. In addition, the availability and reliability of these wireless backup services is totally dependent on the local wireless carrier's actual service coverage range. Due to high volume congestion and the well known dropped calls experienced at peak usage times, wireless cellular communication is not dependable enough for alarm reporting, and therefore does not provide a reliable backup option.

Today, for the most part, alarm reporting service providers continue to support DTMF communications services for subscribers that have older DTMF-only equipment. However, with the objective of obtaining a higher level of efficiency, a newer communications protocol for alarm reporting has been widely accepted and implemented by security industry leaders. That method, referred to as the “Ademco Contact ID” protocol, uses a relatively low-speed but very dependable end-to-end modem communications routine. This format contains a four-digit account number, a pin status, a three-digit alarm code, a two digit area number and a three digit zone or user number. The Ademco Contact-ID format can be depicted as follows:
AAAA P CCC XX ZZZ
   where AAAA is the account number, P is the pin status (alarm or restore), CCC is the alarm code (which is pre-defined by Ademco), XX is the area number and ZZZ is the zone or user number. The total number of characters required for a complete alarm reporting session, including delimiters, is seventeen.

Automatic Crash Notification Systems

In addition to home security alarm reporting, there have been efforts to develop a reliable Automatic Crash Notification (ACN) system to enhance the response time of rescue personnel in responding to vehicular crashes. Some vehicle manufacturers have developed ACN systems that are activated by the deployment of a vehicle's air bag system. Use of airbag deployment to activate ACN systems is preferred because air bag systems are virtually standard in new car models. The major system components of the air bag systems are the crash sensors, air bag control system, inflator and the air bag. The air bag control system generally includes control modules that provide direct access via external connectors to continuous real time system data, including air bag deployment alerts which can be used to activate an ACN system.

An example of such an ACN system currently on the market is the OnStar™ in-vehicle safety and communications system offered by General Motors Corporation as an option on select vehicles. The OnStar™ system uses local wireless cellular services to report notice of a crash to an OnStar™ call center system, which then makes emergency information available to a local 911 operator so that appropriate life-saving personnel and equipment can be dispatched to crash scenes. In addition to the aforementioned reliability problems inherent in the cellular services used by OnStar™, there are also coverage availability concerns, particularly in rural areas where about sixty percent of the nation's automotive fatalities occur. Traffic safety and emergency medical experts agree that an ACN system is much more critical in rural areas, where there may not be a passerby to report a crash for a long time after the crash, and where there are fewer local hospitals equipped to treat the kinds of injuries sustained in severe crashes.

Hence, there is a need for a low-cost ACN system that is activated by the deployment of the vehicle's air bag system and which is capable of communicating a crash alert to rescue personnel over a reliable, widely available wireless communication system.

GPS System

Some exiting ACN systems make use of the Global Positioning System (GPS). GPS, which is comprised of a constellation of over twenty-four satellites, provides the only truly global satellite navigation system. GPS can be used to determine one's precise location and to provide a highly accurate time reference almost anywhere on Earth or in Earth orbit. The accuracy of the GPS is about 5 meters (16 feet) as of 2005, and has steadily improved over the last several years. Using differential GPS and other error-correcting techniques, its accuracy can be improved to about 1 centimeter (0.4 inches) over short distances. Although the GPS satellite system was designed by and is controlled by the United States Department of Defense primarily for military purposes, it can be used by anyone, free of charge. In the realm of global emergency systems, use of GPS is particularly important in situations where the location of a person needing assistance is not fixed or known.

Cospas-Sarsat System

While GPS can be used to obtain the coordinates of an individual's location, it does not provide a means to transmit and process emergency alerts. This need is addressed by Cospas-Sarsat. Cospas-Sarsat is an international search and rescue system that uses satellites to detect and locate emergency beacons carried by ships, aircrafts or individuals. This system consists of a network of satellites, ground stations which are referred to as Local User Terminals (LUTs), mission control centers and rescue coordination centers. Each satellite in the Cospas-Sarsat system can detect alert signals transmitted from 406 MHz beacons that are in the satellite's reception footprint. The satellite then relays the alert signal to a LUT when the satellite is within view of the LUT. The Cospas-Sarsat system also allows for the encoding of position data and other data in the transmitted 406 MHz message, thereby providing for quasi-real time alerting with position information. The position data can be obtained from a GPS receiver connected to the emergency beacon transmitter and encoded into the message string transmitted by the beacon.

Since its deployment, the Cospas-Sarsat system has provided a tremendous resource for protecting the lives of aviators and mariners that was unthinkable prior to the space age. Prior to 1995, there were only two types of beacons approved for use in the United States within the Cospas-Sarsat system: (1) Emergency Locator Transmitters (ELT) for aircraft and (2) Emergency Position Indicating Radio Beacons (EPIRB) for maritime vessels. In 1995, the United States allowed testing of personal locator beacons (PLBs) in the harsh terrain of the State of Alaska. In 2003, as a result of the success of the test in Alaska, the Federal Communications Commission (FCC) approved the use of PLBs in all of the United States for private and personal use. Since then, many lives and millions of taxpayer dollars have been saved due to search and rescue operations assisted by the use of this satellite-based technology.

GOES DCS System

The Geostationary Operational Environmental Satellite (GOES) Data Collection System (DCS) is a US based satellite system designed to facilitate the collection of environmental data from remote locations around the world. Although the system is run by the National Oceanic and Atmospheric Administration (NOAA), it is also used by other countries and links into other environmental satellite systems run by other countries. It can also be used for government supported applications in the US that fall outside of true environmental data gathering applications.

The DCS system is a payload on the GOES satellites, and is similar to the Cospas-Sarsat 406 MHz payload. However there are some differences between the two systems. Like the Cospas-Sarsat system, there is currently no cost for using the DCS system. DCS is an environmental data gathering system used mainly by scientists, and it is not primarily intended as a safety-of-life application. DCS operates on a different link budget principle as compared to Cospas-Sarsat. Some DCS messages are routed only thru the GOES-East or GOES-West satellites, not both as is the case with Cospas-Sarsat. The DCS and Cospas-Sarsat systems are similar in concept and design, but differ somewhat in the transmitted power levels, the transmitted data message and the encoding methods. The amount of data that can be sent over DCS is significantly greater than over Cospas-Sarsat, and the data rate is higher as well (up to 13,040 bits at 300 bits per second). There is a return link in the DCS system that allows communication and the transmission of messages from NOAA via the satellites to terrestrial transceivers.

In the Cospas-Sarsat system, the Air Force Rescue Coordination Center (AFRCC) (represented by reference number 34 in FIG. 2) is the government agency responsible for handling inland distress calls in the United States received over Cospas-Sarsat. Now that Cospas-Sarsat is available for private and personal use, the AFRCC is not set up to handle the potential workload that could be generated by thousands of consumer devices that could utilize the system as the primary means of communicating emergency alerts in the near future.

Therefore, a system is needed that can harness the global reliability of GPS and the Cospas-Sarsat satellite system and other such wide-coverage satellite systems (such as GOES DCS) to facilitate the transmission of alert signals from emergency notification systems, such as security systems, fire alarm systems, mass occupant notification systems and ACN systems, without overwhelming the infrastructure that currently handles distress alert signals. Such a system would also free up resources of the AFRCC to concentrate on its core mission of saving downed pilots.

Also, a wireless alarm communication system is needed that is globally ubiquitous and not prone to service outages due to high volume of use, power failures, or natural disaster, and which is capable of communication using industry standard protocols.

### SUMMARY

The above and other needs are met by an apparatus which combines emergency event detection means with a wireless beacon capable of communicating with the Cospas-Sarsat and other wide-coverage satellite systems. With this combination, the invention provides for reliably transmitting information about emergency events via such satellite systems. The invention further provides for forwarding alarm and emergency event messages to a third-party monitoring service which coordinates a response to the alarm or emergency event. In this way, alarms and emergency events can be reliably handled without overwhelming limited government search and rescue resources.

In some embodiments the invention provides an emergency event reporting apparatus that operates in conjunction with a satellite-based data relay system. The emergency event reporting apparatus includes an emergency alert transmission system and an emergency alert management system. The emergency alert transmission system is for transmitting emergency alert messages upon detection of an emergency event. The emergency alert transmission system includes one or more emergency alert sensors, an alarm control panel and an alarm beacon unit. The emergency alert sensors are for detecting characteristics associated with the emergency event and generating one or more sensor signals based thereon. The alarm control panel is for receiving the sensor signals and generating alarm signals based thereon. The alarm beacon unit is for receiving the alarm signals and transmitting an alert message based on the alarm signals. The alert message includes identification information and alert message information regarding the alarm signals. The alarm beacon unit transmits the alert message at a frequency and in a format compatible with reception and processing by satellites associated with the satellite-based data relay system. The emergency alert management system is operable to receive communications from the satellite-based data relay system, and to extract from the communications the identification information and the alert message information.

The alarm beacon unit may also include a landline telephone connection for communicating the alert message via a telephone landline and a wireless transmission module operable to wirelessly transmit the alert message. In this embodiment, a monitoring device, such as a controller or processor, monitors the landline telephone connection to determine whether the telephone landline is available for communicating the alert message. When the telephone landline is not available for communicating the alert message, the monitoring device activates the wireless transmission module to wirelessly transmit the alert message.

In some embodiments, the alarm beacon includes first and second wireless transmission modules that are operable to wirelessly transmit the alert message. A monitoring device monitors the status of the first wireless transmission module to determine whether the first wireless transmission module is available to wirelessly transmit the alert message. When the first wireless transmission module is not available to wirelessly transmit the alert message, the monitoring device activates the second wireless transmission module to wirelessly transmit the alert message.

The first or second wireless transmission modules may be operable to wirelessly transmit the alert message at a frequency and in a format compatible with reception and processing by satellites associated with one or more of the following satellite-based data relay systems: Cospas-Sarsat, GOES DCS, Inmarsat, Iridium, ORBCOMM, Globalstar and Mobile Satellite Ventures (MSV).

In another aspect, the invention provides a method for transmitting notice of an emergency event from an emergency event reporting apparatus. In a preferred embodiment, the method includes the following steps:
(a) detecting one or more characteristics associated with the emergency event and generating one or more alarm signals based thereon;
(b) transmitting an alert message at a frequency and in a format compatible with reception and processing by satellites associated with a satellite-based data relay system, where the alert message includes identification information and alert message information regarding the one or more alarm signals;
(c) relaying the alert message via the satellite-based data relay system to an emergency alert management system;
(d) extracting at least the identification information from the alert message;
(e) determining an emergency alert recipient system to be notified of the emergency event, where the determination is based at least in part on the identification information; and
(f) notifying the emergency alert recipient system of the emergency event.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts an emergency event reporting system according to a preferred embodiment of the invention;

FIG. 2 depicts further aspects of the emergency event reporting system of FIG. 1 according to one embodiment of the invention;

FIG. 3 depicts an alarm beacon unit of the emergency event reporting system according to one embodiment of the invention;

FIG. 4 depicts a flowchart describing a process for transmitting notice of an emergency event according to an embodiment of the invention; and

FIGS. 5A-5H depict signal timing diagrams for a process for transmitting alarm messages according to an embodiment of the invention.

### DETAILED DESCRIPTION

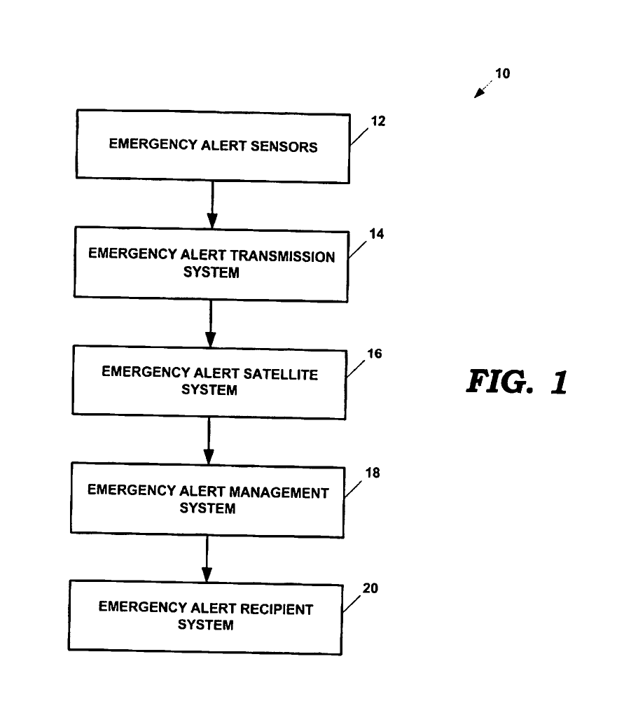

FIG. 1 depicts a functional block diagram of a system 10 for reporting emergency events. The major components of the system 10 include one or more emergency alert sensors 12, an emergency alert transmission system 14, an emergency alert satellite system 16 such as the Cospas-Sarsat system, an emergency alert management system 18 and an emergency alert recipient system 20. Each of these system components is described in more detail herein.

The emergency alert sensors 12 detect the occurrence of an emergency event. In one embodiment where the invention is used in a building security system, the emergency alert sensors 12 comprise sensors for detecting fire, smoke, carbon monoxide, motion or forced entry. In another embodiment where the invention is used in an automatic crash notification (ACN) system, the emergency alert sensors 12 comprise sensors for detecting a vehicle crash, such as by monitoring for airbag deployment. The emergency alert sensors 12 may also comprise one or more buttons or other activation devices that may be manually operated by a person in the event of an emergency situation.

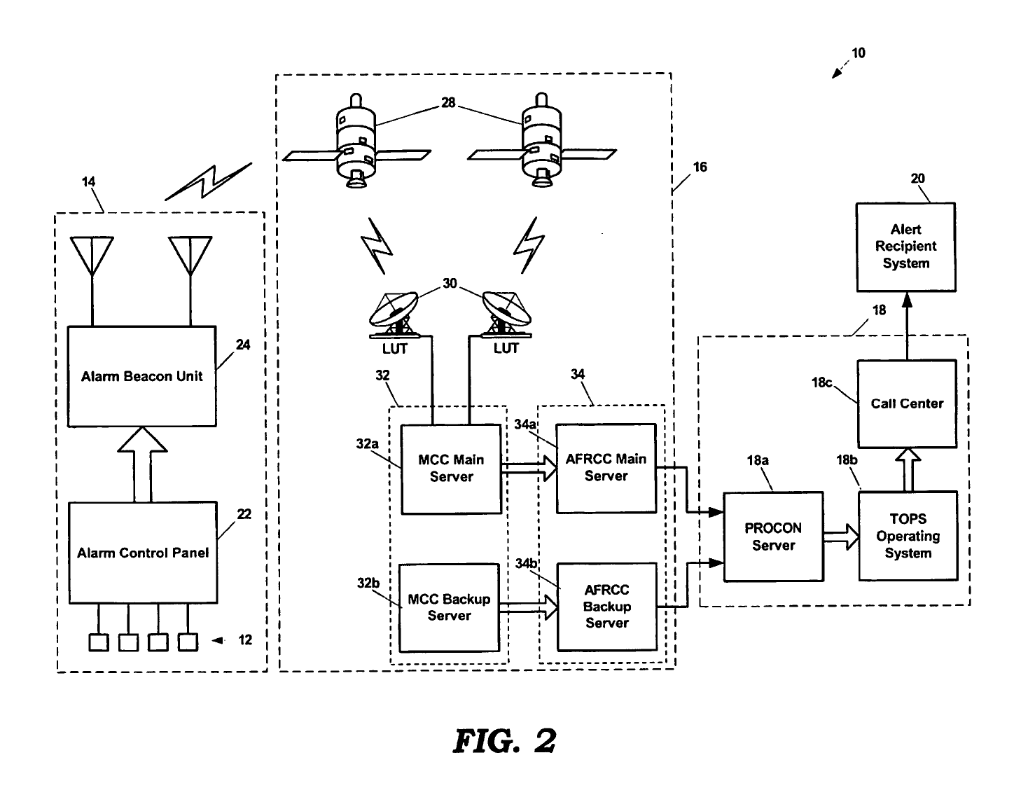

In one embodiment depicted in FIG. 2, the emergency alert transmission system 14 comprises a security system alarm control panel 22 and an alarm beacon unit 24. The alarm panel 22 is operable to receive sensor signals from the sensors 12 and generate alarm signals based on the received sensor signals. In one exemplary embodiment, the alarm panel 22 outputs four alarm signals (designated A1, A2, A3 and A4) to the alarm beacon unit 24. Further description of the alarm signals is provided hereinafter. In various embodiments, the emergency alert transmission system 14 may be installed in a fixed location, disposed in a vehicle or other mobile asset, or provided in a handheld portable housing.

Upon receipt of an alarm signal from the alarm panel 22, the alarm beacon unit 24 begins transmitting a beacon signal, such as at a frequency of about 406.037 MHz which is compatible with the COSPAS-SARSAT system 16. It will be appreciated that the beacon unit 24 may operate at other frequencies as necessary to communicate with the COSPAS-SARSAT system 16 or other data relay satellite systems. As described in more detail below, the beacon signal is encoded with a unique identification number (UIN) which identifies the beacon unit 24 and an alarm code indicating which of the alarm signals initiated activation of the beacon unit 24. The transmitted alarm code may also indicate an internal alarm condition (designated as A5) generated during an internal test of the beacon unit 24.

As shown in FIG. 2, upon receipt of a beacon signal transmitted from the beacon unit 24, the COSPAS-SARSAT system 16 forwards an alert message via the satellites 28, LUT's 30 and mission control center (MCC) 32 to the US Air Force Rescue Coordination Center (AFRCC) 34. When an alert message reaches the USAFRCC 34, the routing of the message depends on the identification number of the emergency alert transmission system 14 that transmitted the alert message. If the identification number is registered with a third-party private monitoring entity, the alert message is forwarded to the emergency alert management system 18 associated with the private monitoring entity. One example of a third-party private monitoring entity is PROCON, Inc., which operates an emergency alert management system 18, also referred to herein as the PROCON hub, in Irvine, Calif.

In an alternative embodiment of the invention, the LUT's 30, mission control center 32 and rescue coordination center (RCC) 34 are operated by a private alert processing entity rather than the U.S. Air Force. In this embodiment, the privately-operated components 30, 32 and 34 act in coordination with LUT's 30, MCC 32 and AFRCC 34 operated by the U.S. Air Force. The privately-operated LUT's 32 receive the alert signals directly from the satellites 28 and pass the alert messages via the privately-operated MCC 32 to the privately-operated RCC 34. If the UIN contained in the alert message is registered to a third-party private monitoring entity 18, then the RCC 34 forwards the alert message to that third-party monitoring entity 18. If the UIN is not registered to a third-party private monitoring entity 18, then the alert message is ignored by the privately-operated RCC 34, with the understanding that it will be handled by the Air Force system. In some situations, the Air Force may contract with a private alert processing entity to also handle alert messages from beacon units that are not registered with a third-party private monitoring entity 18. In that case, the private alert processing entity is acting on behalf of the Air Force in processing the alert messages.

The emergency alert management system 18 is a communication network and computer system capable of receiving and processing emergency alert messages in the standard message format from the COSPAS-SARSAT system 16. As shown in FIG. 2, the emergency alert management system 18 may include one or more server computers 18a running operating system software 18b. The operating system software 18b provides a communication interface between the USAFRCC 34 and the call center computers 18c. In a preferred embodiment, the call center computers 18c are manned around-the-clock by operators trained in handling various emergency situations. One of the functions of the emergency alert management system 18 is to determine what third party alert recipient agency is responsible for responding to alerts generated by the particular emergency alert transmission system 14 that transmitted the alert message. This determination is made based at least in part on the UIN contained in the alert message. If necessary, the emergency alert management system 18 reformats the alert message into a format, such as the ADEMCO contact-ID format, that is compatible with the responsible alert recipient entity. The emergency alert management system 18 then forwards the reformatted message to the alert recipient system 20 associated with the responsible alert recipient entity. In a preferred embodiment, the emergency alert management system 18 maintains simultaneous real-time connectivity to both the USAFRCC 34 of the COSPAS-SARSAT system 16 and the alert recipient system 20. In an alternative embodiment of the invention, the emergency alert management system 18 maybe used to make direct contact with the local emergency services agencies using a database that is a part of the operating system 18b.

The alert recipient system 20 may comprise a computer database and communications system operated by an alert monitoring service provider, which may be a security company such as ADT. In this case, the alert recipient system 20 may include wireless communications, telephones, facsimile machines, the Internet or email services used to notify the alert monitoring service provider of the alert. As described in more detail hereinafter, the alert recipient system 20 receives alert messages from the emergency alert management system 18 and notifies local emergency services agencies regarding the nature and location of the emergency.

In alternative embodiments of the invention, the alert recipient system 20 comprises a computer system associated with a government agency, such as the Department of Homeland Security, the Department of Defense or the Nuclear Regulatory Commission.

The alert recipient system 20 may also comprise a mass occupant notification system at a military base, government research facility, college campus, city center or other such area. Such a mass occupant notification system may comprise a series of towers with loudspeakers for audibly announcing an emergency message to persons in the area.

In yet another embodiment of the invention, the alert recipient system 20 may comprise a computer system associated with a private company or agency, such as an electricity supply company or parks department, that is responsible for the safety of its staff, for example in lone worker situations in remote areas, and is prepared to manage rescue operations under these circumstances.

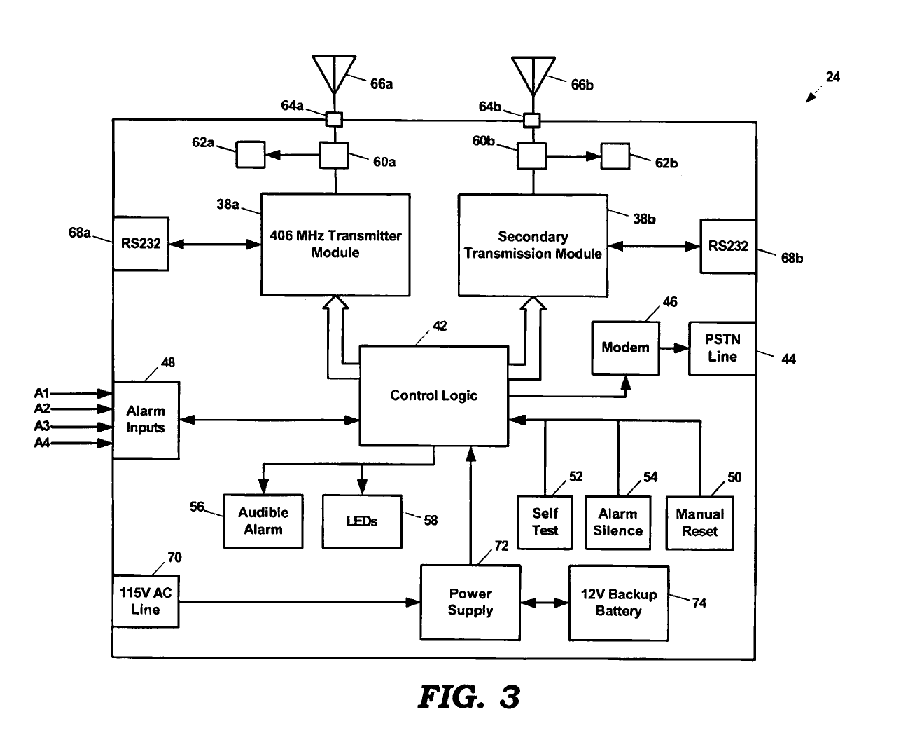

FIG. 3 depicts an embodiment of the alarm beacon unit 24. The alarm beacon unit 24 includes a primary transmission module 38a, a secondary transmission module 38b and control logic circuitry 42 that controls the operation of the primary and secondary transmission modules. In one embodiment, the primary transmission module 38a includes a beacon transmitter operating at about 406 MHz. In the event of an alarm or alert condition, the transmission module 38a is activated to transmit an alert or alarm message containing a UIN and alarm type information as described below. The secondary transmission module 38b acts as a backup in case of malfunction of the primary module 38a. Preferably, all alarm/alert signals are always routed to both modules 38a and 38b, although the secondary module 38b operates only upon failure of the primary module 38b.

In some embodiments of the invention, a Public Switched Telephone Network (PSTN) telephone line input 44 (such as an RJ-11 jack) and modem 46 provide the primary means of communication in case of an alert or alarm signal. In these embodiments, the 406 MHz transmission module 38a serves as the backup transmission means in case of failure of the PSTN telephone line and/or modem. The secondary transmission module 38b may also be provided in these embodiments to act as a secondary backup in case of failure of the PSTN line and the primary transmission module 38a.

In one embodiment, the secondary transmission module 38b is a 406 MHz beacon transmitter. In another embodiment, the secondary transmission module 38b transmits signals that are compatible for communication with the Iridium satellite system. In this case, the Iridium satellite system acts as a backup to the Cospas-Sarsat system 16. In yet another embodiment, the secondary transmission module 38b is compatible with the Inmarsat satellite system. In still another embodiment, the secondary transmission module 38b is a transmitter compatible with the GOES DCS system. The secondary transmission module 38b may also comprise a cellular telephone transmitter. It should be appreciated that any of the communication means, including PSTN, cellular, Cospas-Sarsat, GOES DCS, Iridium, Inmarsat, ORBCOMM, Globalstar and MSV, could serve as the primary transmission means, and any of these communication means could serve as the secondary or backup transmission means.

As shown in FIG. 3, the alarm beacon unit 24 includes alarm inputs 48 for receiving alarm or alert signals from the alarm control panel 22 (FIG. 2) or other source of alarm signals. In a preferred embodiment, the four alarm inputs designated as A1, A2, A3 and A4 are provided to the control logic 42. Each alarm input is preferably driven by a set of isolated normally-open relay contacts which close (short circuit) when an alarm condition is indicated. Based on the closure of one or more sets of the alarm contacts, the control logic 42 modifies the coding of the signal to be transmitted by the primary transmission module 38a (and the secondary transmission module 38b, if applicable) as set forth hereinafter. The control logic 42 then activates the transmission module 38a to transmit an alert signal, preferably within 10 seconds of the contact closure at the alarm input 48.

In a preferred embodiment, the alarm inputs 48 incorporate features to prevent contact bounce and potential transient spikes which can create false alerts. For example, an external relay contact closure of at least 250 ms duration may be required to initiate an alarm condition. Contact closures shorter than this duration may be ignored and so that an alarm signal is not triggered. Once the external relay contacts have been closed for more than 250 ms, an alarm condition is generated, and this condition remains latched until a manual reset is performed, even if the relay contacts open. If a second alarm signal is received on another alarm input after the initiation of a first alarm condition, then the control logic 42 updates the coding of the beacon signal to reflect the change in alarm status and the updated code is transmitted in subsequent transmissions.

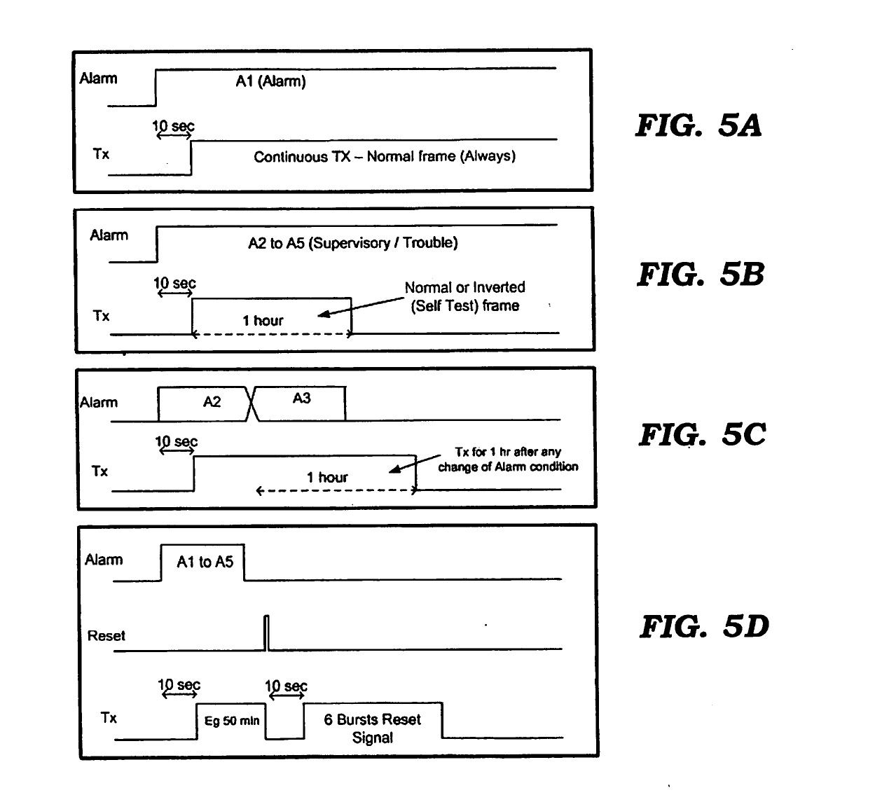

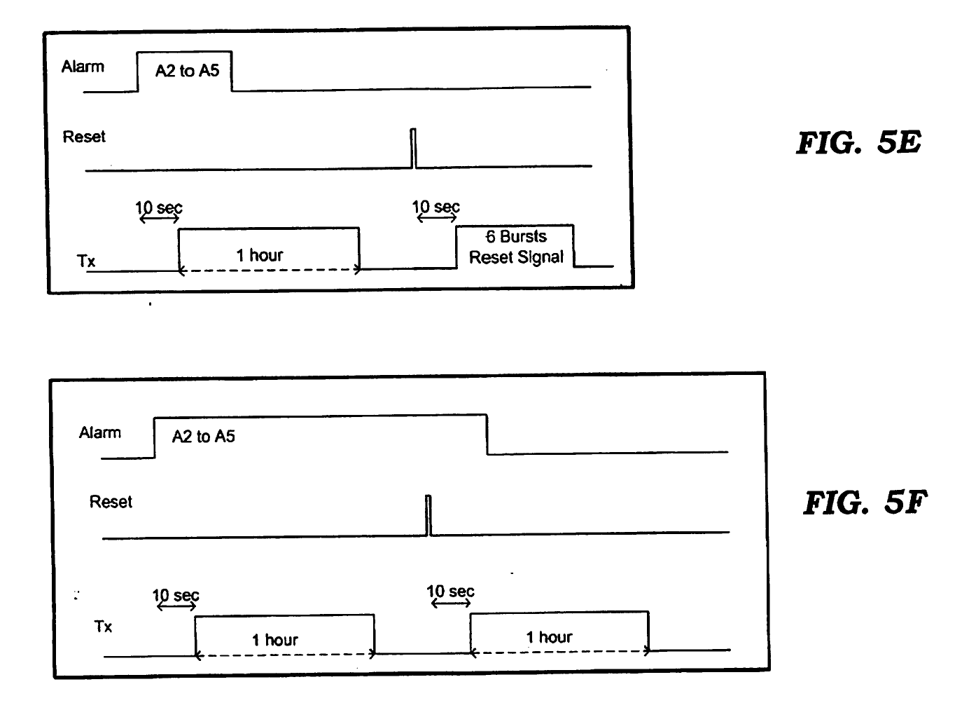

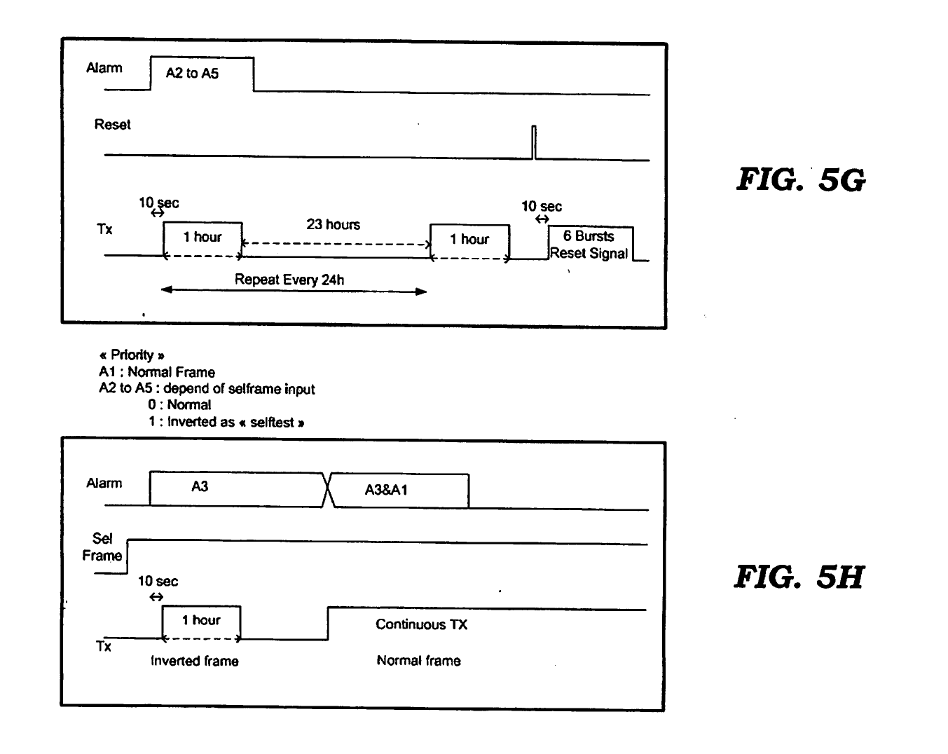

As shown in FIG. 5A, once initiated by an alarm signal on the A1 line, the transmission module 38a is activated to transmit a Normal Frame Sync burst within 10 seconds and continues to transmit a further burst (in accordance with Cospas-Sarsat requirements) every 50 seconds thereafter until there is a manual reset. As shown in FIG. 5B, once initiated by an alarm signal on the A2, A3 or A4 lines or by an internal alarm (A5), the transmission module 38a is activated to transmit either a Normal Frame Sync burst or an Inverted Frame Sync burst (bits 16 to 24 (in the Cospas-Sarsat message) set to 011010000) within 10 seconds. These beacon bursts are then transmitted every 50 seconds (in accordance with Cospas-Sarsat requirements) for a period of about one hour thereafter or until the manual reset button 50 is pressed if sooner. After about an hour, the transmission module 38a ceases transmitting the beacon bursts, unless a new alarm signal has been initiated in the meantime. If a new alarm signal is initiated, as shown in FIG. 5C, the beacon bursts continue to be transmitted every 50 seconds for a period of about one hour after the initiation of the new alarm. In preferred embodiments, the alarm stays active and LED indicators 58 related to the alarm remain lit until the manual reset 50 is pressed. As shown in FIG. 5G, if the unit has not been manually reset after a period of about 23 hours after the alarm condition ceases, then the transmission module 38a continues to transmit the beacon bursts for a further period of one hour. This pattern continues until there is a manual reset. In a preferred embodiment, the selection of Normal Frame or Inverted Frame burst transmissions for alarm signals A2 to A5 is determined by a hardware jumper link on a motherboard of the beacon unit 24.

As shown in FIG. 5F, if an alarm signal is still present on the A2, A3, A4 or A5 input when the manual reset button 50 is pressed, then the alarm transmissions continue until the alarm signal is cleared and the manual reset button 50 is pressed again. This feature applies as well to alarm signal A1. If alarm signal A1 is still present when the manual reset button 50 is pressed, then this alarm transmission continues. As shown in FIGS. 5D, 5E and 5G, if an alarm signal is not still present when the manual reset button 50 is pressed, then the unit 24 is reset back to its “ready” or “standby” condition. About 10 seconds later, the transmission module 38a transmits a “failure corrected” signal to indicate that the alarm condition has been cleared. In this signal, the relevant alarm condition bit of the message is set to “0”, similar to a self test message as discussed hereinafter. The “failure corrected” transmission preferably comprises six bursts spaced 50 seconds apart, after which the unit 24 reverts to the “ready” condition. The “failure corrected” signal may be transmitted with either Normal Frame Sync or Inverted Frame Sync as selected by the jumper link setting.

As shown in FIG. 5H, the hardware jumper link that selects between Normal Frame or Inverted Frame is set to select Inverted Frame. If an alarm signal A2 to A5 is then received (in this example alarm signal A3 is shown), then after about 10 seconds the transmission module 38a is activated to transmit an Inverted Frame Sync burst. These beacon bursts are then transmitted every 50 seconds (in accordance with Cospas-Sarsat requirements) for a period of about one hour thereafter as previously explained and shown in FIG. 5B. If at a later time an alarm signal A1 is also received (both alarm signals A1 and A3 are now present), this alarm signal takes precedence over the A2 to A5 alarm signals (A3 in this case) as shown in FIG. 5H. The presence of the A1 alarm signal then overrides the Inverted Frame jumper link setting and the transmission module 38a is then activated to transmit a Normal Frame Sync burst (containing both the A1 and A3 alarm data) every 50 seconds as shown in FIG. 5A.

The alarm inputs A1-A4 may be monitored for both open circuits and short circuits to ground (e.g. by the use of voltage comparators). Any such fault condition results in the generation of an internal alarm (A5) on the motherboard of the unit 24 which is treated in the same way as any other alarm signal (A1-A4). Open circuit monitoring may be achieved by the use of a 4.7 kΩ resistor across each of the two wire alarm inputs (A1-A4) 48. If the resistance across any of the A1 to A4 inputs is more than about 9.1 kΩ, an A5 alarm signal is generated. If the resistance across any of the A1 to A4 inputs is less than 330Ω, this indicates an alarm condition and causes generation of an A1 to A4 alarm signal as appropriate. Short circuit to ground monitoring is achieved by similar means using a floating electrically isolated ground (which is normally isolated from the rest of the motherboard, apart from a single high impedance reference point) as a reference point with respect to the A1 to A4 alarm inputs 48. If the resistance between ground and any of the alarm inputs 48 drops below about 57.5 kΩ, an A5 alarm signal is generated. Preferably, a Self Test failure also generates an A5 alarm condition and all such events are combined in parallel to generate the final A5 alarm signal. It will be appreciated that the values of resistances selected for alarm monitoring are arbitrary, and the invention is not limited to any particular values.

When pressed, the reset button 50 cancels any and all alarm conditions, stops all transmissions from the primary or secondary transmission modules 38a-38b and sets the encoding of the beacon transmissions back to the normal condition. In the event an alarm condition is still present at an alarm input A1-A5 after the reset button 50 has been pressed, this shall generate another alarm and restart the beacon transmissions (FIG. 5F).

When pressed, the self test button 52 initiates sequential self tests of both transmission modules 38a-38b which preferably involves transmission of standard inverted frame sync bursts in accordance with Cospas-Sarsat protocols. (It should be appreciated that if a different satellite system is used, such as Iridium or Inmarsat, the self test feature may function in a different manner and different parameters may be tested.) In a preferred embodiment, the primary module 38a is tested within five seconds of pressing the self test button 52, and the test of the secondary module 38b is delayed until after the self test of the primary module 38a, which should be no more than about ten seconds after pressing the button 52. The self test function tests various parameters of each transmission module, including power output, PLL lock detect, and internal power. The failure of either self test results in the generation of an A5 alarm.

In addition to causing activation of the transmission module 38a, an A5 alarm condition also causes activation of an audible alarm 56 installed in the beacon unit 24. In a preferred embodiment, the audible alarm 56 comprises a piezoelectric buzzer on the motherboard of the unit 24. The audible alarm 56 is silenced by pressing the alarm silence button 54. Preferably, pressing the alarm silence button 54 does not cancel the A5 alarm condition, but merely stops the audible alarm. The only way to cancel the A5 alarm is to press the reset button 50.

As shown in FIG. 3, the beacon unit 24 includes several LED indicators 56 to provide status information regarding DC Power, Alarms 1-5, which transmission module is transmitting, and self test functions. Activation of the LED indicators 56 is described in more detail hereinafter.

In preferred embodiments, the RF output from each transmission module 38a-38b is routed via a corresponding RF switch 60a-60b to either an antenna connector 64a-64b or to a 50 Ohm dummy load 62a-62b. The normal default position of the switches 60a-60b shall be to connect the RF output from the transmission modules 38a-38b to the antenna connectors 64a-64b. The RF switches 60a-60b are activated to route the RF output to the dummy loads 62a-62b when an automatic internal self test is initiated. This prevents the transmission of any RF signals during the self test operation.

When the RF output is connected to the antenna connectors 64a-64b, the transmitted power level is 5 W as required by Cospas-Sarsat. When the RF output is connected to the dummy load 62a-62b during the self test, the output power level is reduced to 0.5 W to further reduce the chance of any signals being transmitted during the test. The acceptable power threshold associated with the internal self test function that monitors the RF output power level shall be reduced accordingly so that it accurately reports a pass or fail condition of the RF output power in this condition.

In a preferred embodiment of the alarm beacon unit 24, an RS232-compatible input 68a-68b is connected to each transmission module 38a-38b. These inputs 68a-68b are for receiving data in National Marine Electronics Association (NMEA) format from an external GPS receiver and using this data to encode position information into the alert signal transmitted from the beacon transmission module 38a-38b. The inputs 68a-68b are preferably compatible with NMEA 0183 GPS message types GGA, GLL and RMC.

Each transmission module 38a-38b has a UIN which is encoded in the RF transmissions from the module 38a-38b. Further details regarding the encoding schemes are provided hereinafter.

As mentioned above, each transmission module 38a-38b preferably includes a self test function which monitors the module performance when the self test button 52 is pressed, or when the automatic internal self test occurs, or when the module 38a-38b is transmitting a distress alert. Each transmission module 38a-38b provides a self test fail signal to the control logic 42 which causes activation of a self test fail LED, initiates the A5 alarm condition and enables distress transmissions via an alternative transmission means. In normal operation, the primary transmission module 38a is enabled and the secondary transmission module 38b is disabled. If the self test of the primary module 38a indicates a fail condition, the self test fail signal goes high. This causes activation of the self test fail LED, initiates an A5 alarm condition, and enables the secondary transmission module 38b which begins transmitting the A5 alarm (and any other alarm conditions that maybe present). If the secondary transmission module 38b indicates self test fail condition, then the self test fail signal goes high, the self test fail LED is activated, an A5 alarm condition is initiated, and the primary transmission module 38a continues to transmit.

In various embodiments of the invention, transmissions from the primary and secondary transmission modules 38a-38b are encoded using either Serial User Protocol, Test User Protocol or National User Protocol as set forth in Tables I, II and III below. It will be appreciated that the data encoding formats set forth in Tables I, II and III provide an example of operation in association with the Cospas-Sarsat system. If a different satellite system is used, such as Iridium, other data encoding formats would apply.

TABLE I
Serial User Protocol

| | | | Standard | |
|---|---|---|---|---|
| | | | Cospas- | |
| | | | Sarsat & | |
| | | | NOAA | |
| Bits | Bit Field Name | Bit Coding | Format | Remarks |
| 1 to 15 | Bit Synchronization | All 1's | Yes | |
| 16 to 24 | Frame Synchronization | 000101111 | Yes | |
| 25 | Format Flag | 0 | Yes | Short Message |
| 26 | Protocol Flag | 1 | Yes | User Protocol |
| 27 to 36 | Country Code | 0101101110 | Yes | USA Code 366 |
| 37 to 39 | Protocol Code | 011 | Yes | Serial User |
| 40 to 42 | Beacon Type | 110 | Yes | PLB (land use) |
| 43 | C/S TAC | 0 | Yes | No C/S TAC No encoded |
| 44 to 51 | Manufacturer Block ID | 00100100 | Yes | Allocated by NOAA, Procon = 36 |
| 52 to 63 | Manufacturer Sequence No | Any | Yes | Allocated by Procon |
| 64 to 67 | Manufacturer Model No | Any | Yes | Allocated by Procon |
| 68 to 75 | Manufacturer Production | Any | Yes | Allocated by Procon |
| | Run No | | | |
| 76 to 83 | Spare Bits | Any | No | Allocated by Procon in agreement |
| | | | | with NOAA |
| 84 to 85 | Aux Radio Locating | 00 | Yes | ‘00’ No 121 Homer Fitted |
| 86 to 106 | BCH Error Correcting Code | As calculated | Yes | |
| 107 | Emergency Code Flag | 0 | Yes | |
| 108 | Activation Code | 0 | Yes | ‘0’ = Manual Activation |
| 109 to 112 | Emergency Code/National | 0000 | Yes | Not Used |
| | Use | | | |

TABLE II
Test User Protocol

| | | | Standard | |
|---|---|---|---|---|
| | | | Cospas- | |
| | | | Sarsat & | |
| | | Procon Bit | NOAA | |
| Bits | Bit Field Name | Coding | Format | Remarks |
| 1 to 15 | Bit Synchronization | All 1's | Yes | |
| 16 to 24 | Frame Synchronization | 000101111 | Yes | |
| 25 | Format Flag | Any | Yes | 0 = Short, 1 = Long Message |
| 26 | Protocol Flag | 1 | Yes | User Protocol |
| 27 to 36 | Country Code | 0101101110 | Yes | USA Code 366 |
| 37 to 39 | Protocol Code | 111 | Yes | Test User |
| 40 to 85 | National Use | Any | Yes | To be agreed with NOAA |
| 86 to 106 | BCH Error Correcting Code | As calculated | Yes | |
| 107 | Emergency Code Flag | 0 | Yes | |
| 108 | Activation Code | 0 | Yes | ‘0’ = Manual Activation |
| 109 to 112 | Emergency Code/National | 0000 | Yes | Not Used |
| | Use | | | |

TABLE III
National User Protocol

| | | | Standard | |
|---|---|---|---|---|
| | | | Cospas- | |
| | | | Sarsat & | |
| | | Procon Bit | NOAA | |
| Bits | Bit Field Name | Coding | Format | Remarks |
| 1 to 15 | Bit Synchronization | All 1's | Yes | |
| 16 to 24 | Frame Synchronization | 000101111 | Yes | |
| 25 | Format Flag | Any | Yes | 0 = Short, 1 = Long Message |
| 26 | Protocol Flag | 1 | Yes | User Protocol |
| 27 to 36 | Country Code | 0101101110 | Yes | USA Code 366 |
| 37 to 39 | Protocol Code | 100 | Yes | National User |
| 40 to 85 | National Use | Any | Yes | To be agreed with NOAA |
| 86 to 106 | BCH Error Correcting Code | As calculated | Yes | |
| 107 to 112 | National Use | Any | Yes | To be agreed with NOAA |
| 113 to 132 | National Use (if using Long | Any | Yes | To be agreed with NOAA |
| | Message) | | | |
| 133 to 144 | BCH Error Correcting Code | As calculated | Yes | |
| | (if using Long Message) | | | |

If the Serial User Protocol is used, bits 44 to 51 identify the manufacturer of the transmission module or the third-party entity associated with the emergency alert management system 18. For example, NOAA has issued PROCON, Inc. a UIN of ‘36’ for this purpose.

These beacon transmission encoding schemes provide for the inclusion of additional information associated with the manufacturer of the beacon unit 24 and/or the transmission modules 38a-38b. For example, the Serial User Protocol includes “spare” bits 76 to 83 which may be used for this purpose. In the Test User Protocol, bits 40 to 85 may be used for this purpose, and in the National User Protocol, bits 113 to 132 may be so used. The default condition for these bits will always be ‘0000 0000’ in order to permit a consistent 15 Hex ID to be obtained from each transmission module 38a-38b during its self test.

In preferred embodiments of the invention using the Serial User Protocol, a manufacturer sequence number (such as a serial number) is encoded into bits 52 to 63 of the message starting at 0001 and going up to 4095. When combined with a manufacturer production run number this will uniquely identify every transmission module/beacon. Likewise, a unique manufacturer model number is encoded into bits 64 to 67 of the message starting at 01 and going up to 15. This number can be used to identify different types of beacons from a particular manufacturer. The manufacturer production run number is encoded into bits 68 to 75 of the message starting at 001 and going up to 255. When combined with the manufacturer sequence number, this uniquely identifies every transmission module/beacon from every manufacturer.

According to one preferred embodiment, each of the “spare” bits (76 to 83) of the Serial User Protocol has been allocated to indicate the alarm condition(s) that initiated the beacon transmission. The default for all of these bits is “0” in order to maintain a repeatable beacon 15 Hex ID. The “active” condition for each of these bits is “1”. In this instance, a high bit 76 indicates an Alarm 1 condition, a high bit 77 indicates an Alarm 2 condition, a high bit 78 indicates an Alarm 3 condition, a high bit 79 indicates an Alarm 4 condition, and a high bit 80 indicates an Alarm 5 condition. In this embodiment, bits 81 to 83 inclusive are not used and remain at “0”. Similarly, in embodiments using the Test User Protocol (or National User Protocol), bit 40 (or 113) is allocated to Alarm 1, bit 41 (or 114) to Alarm 2, bit 42 (or 115) to Alarm 3, etc.

Power for the beacon unit 24 is provided via a 115 VAC supply 70 which is converted to 12 VDC by a power supply unit 72. A 12 VDC battery 74 is included to provide backup power in case of a power failure on the 115 VAC line.

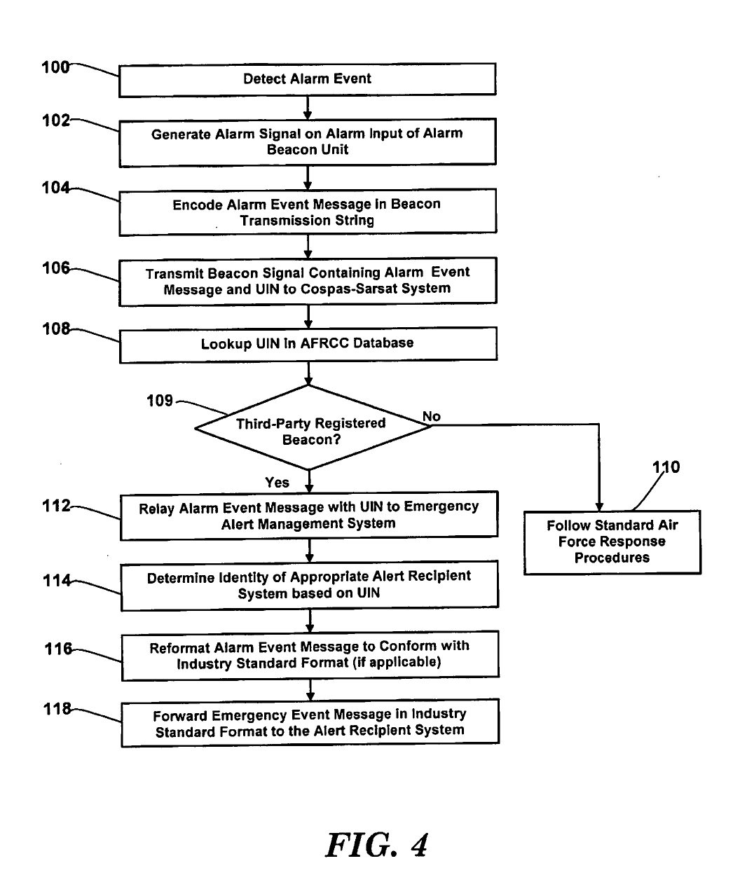

FIG. 4 summarizes steps of a preferred embodiment of a method for reporting alarm events detected by the system 10 depicted in FIGS. 2 and 3. When an alarm event is detected (step 100), the alarm panel 22 generates one or more alarm signals A1-A4 on the alarm inputs 48 (step 102). Based on the alarm signal(s) A1-A4, the alarm beacon unit 24 encodes a beacon transmission string according to one of the encoding schemes depicted in Tables I, II or III, which string includes the unique identification number (UIN) of the beacon unit 24 and an indication of which alarm signal(s) initiated the transmission (step 104). The primary (or secondary) transmission module 38a (or 38b) then powers up and begins transmitting the alarm message string in bursts to the satellites 28 of the COSPAS-SARSAT system 16 (step 106).

The alarm message is relayed to the AFRCC 34 of the COSPAS-SARSAT system 16, where the UIN is looked up in a database containing a listing of all beacon UINs in association with third-party monitoring services with which the UIN is registered (step 108). If the database query results in a finding that the UIN is not registered with a third-party monitoring service (step 109), then standard Air Force emergency event response procedures are followed (step 110). If, on the other hand, the database query results in a finding that the UIN is registered with a third-party monitoring service (step 109), then the alarm event message with the UIN is relayed to the emergency alert management system 18 (step 112). In embodiments wherein the emergency alert management system 18 operates its own private LUT 30, the step 112 may be performed from the LUT 30. Based on the UIN, the emergency alert management system 18 determines which alert recipient system 20 is to receive the alarm message (step 114). For example, if the UIN is registered to ADT, the alarm message will be forwarded to an alert recipient system 20 operated by ADT. In some embodiments, the alarm event message is then reformatted to conform with an industry standard alarm reporting protocol, such as the Contact-ID standard (step 116), and the message is forwarded to a central station of the appropriate alert recipient system 20 (step 118), such as via an outbound T-1 channel.

The embodiments described above are applicable to home, business and military security systems, emergency alert notification systems and automatic vehicle crash notification systems. It will be appreciated that the invention is also applicable to other emergency event reporting situations. For example, embodiments of the invention may be used to report emergency events as detected by sensors installed on a hazardous materials (HAZMAT) delivery vehicle. These embodiments aid in the protection of hazardous materials during transport and protection of the driver's security in the event of a hostile takeover or an accident.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An emergency event reporting apparatus that operates in conjunction with a satellite-based data relay system, the emergency event reporting apparatus comprising:
an emergency alert transmission system for transmitting emergency alert messages upon detection of an emergency event, the emergency alert transmission system comprising:
one or more emergency alert sensors for detecting characteristics associated with the emergency event and generating one or more sensor signals based thereon;
an alarm control panel for receiving the one or more sensor signals and providing one or more alarm signals based on the one or more sensor signals; and
an alarm beacon unit for receiving the alarm signals and transmitting an alert message based on the one or more alarm signals, the alert message including identification information and alert message information regarding the one or more alarm signals, the alarm beacon unit for transmitting the alert message at a frequency and in a format compatible with reception and processing by satellites associated with the satellite-based data relay system; and
an emergency alert management system in communication with the satellite-based data relay system, the emergency alert management system operable to receive communications from the satellite-based data relay system, and to extract from the communications the identification information and the alert message information.

2. The emergency event reporting apparatus of claim 1 further comprising an emergency alert recipient system in communication with the emergency alert management system, the emergency alert recipient system comprising one or more computers associated with a private alarm monitoring company.

3. The emergency event reporting apparatus of claim 1 further comprising an emergency alert recipient system in communication with the emergency alert management system, the emergency alert recipient system comprising one or more computers associated with a public emergency response agency.

4. The emergency event reporting apparatus of claim 1 further comprising an emergency alert recipient system in communication with the emergency alert management system, the emergency alert recipient system comprising one or more remote alert stations operable to annunciate alarm messages to persons occupying areas adjacent the one or more remote alert stations, where the annunciation of the alarm messages is based at least in part on the alert message information.

5. The emergency event reporting apparatus of claim 1 wherein the alarm beacon unit further comprises:
a landline telephone connection for communicating the alert message via a telephone landline;
a wireless transmission module operable to wirelessly transmit the alert message; and
a monitoring device for monitoring the landline telephone connection to determine whether the telephone landline is available for communicating the alert message, and for activating the wireless transmission module to wirelessly transmit the alert message when the telephone landline is not available for communicating the alert message.

6. The emergency event reporting apparatus of claim 5 wherein the wireless transmission module is operable to wirelessly transmit the alert message at a frequency and in a format compatible with reception and processing by satellites associated with the satellite-based data relay system selected from the group consisting of a Cospas-Sarsat satellite system, a GOES DCS satellite system, an Inmarsat satellite system, an Iridium satellite system, an ORBCOMM satellite system, a Globalstar satellite system and a Mobile Satellite Ventures (MSV) satellite system.

7. The emergency event reporting apparatus of claim 1 wherein the alarm beacon unit further comprises:
a first wireless transmission module operable to wirelessly transmit the alert message;
a second wireless transmission module operable to wirelessly transmit the alert message;
a monitoring device for monitoring status of the first wireless transmission module to determine whether the first wireless transmission module is available to wirelessly transmit the alert message, and for activating the second wireless transmission module to wirelessly transmit the alert message when the first wireless transmission module is not available to wirelessly transmit the alert message.

8. The emergency event reporting apparatus of claim 7 wherein:
the first wireless transmission module is operable to wirelessly transmit the alert message at a frequency and in a format compatible with reception and processing by satellites associated with the satellite-based data relay system selected from the group consisting of a Cospas-Sarsat satellite system, a GOES DCS satellite system, an Inmarsat satellite system, an Iridium satellite system; an ORBCOMM satellite system, a Globalstar satellite system and a Mobile Satellite Ventures (MSV) satellite system.
the second wireless transmission module is operable to wirelessly transmit the alert message at a frequency and in a format compatible with reception and processing by satellites associated with the satellite-based data relay system selected from the group consisting of a Cospas-Sarsat satellite system, a GOES DCS satellite system, an Inmarsat satellite system, an Iridium satellite system, an ORBCOMM satellite system, a Globalstar satellite system and a Mobile Satellite Ventures (MSV) satellite system.

9. The emergency event reporting apparatus of claim 7 wherein:
the first wireless transmission module is operable to wirelessly transmit the alert message at a frequency and in a format compatible with reception and processing by a cellular telephone network; and
the second wireless transmission module is operable to wirelessly transmit the alert message at a frequency and in a format compatible with reception and processing by satellites associated with the satellite-based data relay system selected from the group consisting of a Cospas-Sarsat satellite system, a GOES DCS satellite system, an Inmarsat satellite system, an Iridium satellite system an ORBCOMM satellite system, a Globalstar satellite system and a Mobile Satellite Ventures (MSV) satellite system.

10. The emergency event reporting apparatus of claim 1 wherein the identification information in the alert message uniquely identifies the alarm beacon unit.

11. The emergency event reporting apparatus of claim 1 wherein the one or more emergency alert sensors comprise one or more sensor selected from the group consisting of heat sensors, smoke sensors, radiation sensors, motion sensors, hazardous gas sensors, glass-break sensors, forced-entry sensors and portal entry sensors.

12. The emergency event reporting apparatus of claim 1 wherein the one or more emergency alert sensors comprise one or more push buttons for manually activating the alarm beacon unit.

13. A method for transmitting notice of an emergency event from an emergency event reporting apparatus, the method comprising the steps of:
(a) detecting one or more characteristics associated with the emergency event and generating one or more alarm signals based thereon;
(b) transmitting an alert message at a frequency and in a format compatible with reception and processing by satellites associated with a satellite-based data relay system, the alert message including identification information and alert message information regarding the one or more alarm signals;
(c) relaying the alert message via the satellite-based data relay system to an emergency alert management system;
(d) extracting at least the identification information from the alert message;
(e) determining an emergency alert recipient system to be notified of the emergency event, where the determination is based at least in part on the identification information; and
(f) notifying the emergency alert recipient system of the emergency event.

14. The method of claim 13 wherein step (a) comprises detecting one or more characteristics selected from the group consisting of heat characteristics, smoke characteristics, radiation characteristics, motion characteristics, hazardous gas characteristics, glass-break characteristics, forced-entry characteristics and portal entry characteristics.

15. The method of claim 13 wherein step (b) comprises transmitting an alert message at a frequency and in a format compatible with reception and processing by satellites associated with the satellite-based data relay system selected from the group consisting of a Cospas-Sarsat satellite system, a GOES DCS satellite system, an Inmarsat satellite system, an Iridium satellite system, an ORBCOMM satellite system, a Globalstar satellite system and a Mobile Satellite Ventures (MSV) satellite system.

16. The method of claim 13 further comprising monitoring status of a first wireless transmission module to determine whether the first wireless transmission module is available to wirelessly transmit the alert message, and activating a second wireless transmission module to wirelessly transmit the alert message when the first wireless transmission module is not available to wirelessly transmit the alert message.

17. The method of claim 13 further comprising monitoring status of a telephone landline to determine whether the telephone landline is available to communicate the alert message, and activating a wireless transmission module to wirelessly transmit the alert message when the telephone landline is not available to communicate the alert message.

18. The method of claim 13 further comprising monitoring status of a cellular telephone network to determine whether the cellular telephone network is available to communicate the alert message, and activating a wireless transmission module to wirelessly transmit the alert message when the cellular telephone network is not available to communicate the alert message.

19. The method of claim 13 wherein step (f) comprises notifying an emergency alert recipient system selected from the group consisting of
one or more computers associated with a private alarm monitoring company,
one or more computers associated with a public emergency response agency, and
one or more remote alert stations operable to annunciate alarm messages to persons occupying areas adjacent the one or more remote alert stations.

20. An apparatus for transmitting notice of an emergency event, the apparatus comprising:
means for detecting one or more characteristics associated with the emergency event and generating one or more alarm signals based thereon;
means for transmitting an alert message at a frequency and in a format compatible with reception and processing by satellites associated with a satellite-based data relay system, the alert message including identification information and alert message information regarding the one or more alarm signals;
means for relaying the alert message via the satellite-based data relay system to an emergency alert management system;
means for extracting at least the identification information from the alert message;
means for determining an emergency alert recipient system to be notified of the emergency event, where the determination is based at least in part on the identification information; and
means for notifying the emergency alert recipient system of the emergency event.
